(19) United States
(12) Patent Application Publication
(10) Pub. No.: US 2026/0017946 A1
(43) Pub. Date: Jan. 15, 2026

(54) AI ENHANCED UNIFIED SECURITY SYSTEM

(71) Applicant: EyeZense, Inc., Newark, CA (US)

(72) Inventors: Steven Yung, Newark, CA (US); Keijie Bao, Sunnyvale, CA (US); Shurui Shang, San Jose, CA (US); Wade Luders, San Jose, CA (US); Sharvan Kumar, Newark, CA (US); Phillip Doan, San Jose, CA (US)

(21) Appl. No.: 18/648,178

(22) Filed: Apr. 26, 2024

Related U.S. Application Data
(60) Provisional application No. 63/462,859, filed on Apr. 28, 2023.
(60) Provisional application No. 63/621,902, filed on Jan. 17, 2024.
(60) Provisional application No. 63/624,204, filed on Jan. 23, 2024.
(60) Provisional application No. 63/624,211, filed on Jan. 23, 2024.

(51) Int. Cl. G06V 20/40; G06F 1/16

(52) U.S. Cl. CPC G06V 20/41; G06F 1/163

(57) ABSTRACT

A Security System comprises (1) a Wearable Edge Computing AI Chipset (Edge AI) interoperating with one or more Cameras into a Wearable Security System, In-Vehicle Security System, and a Home Security System as part of the Unified AI (Artificial Intelligence) Security System. The security system contains one or more GPS tracked devices that utilizes either an Edge Computing AI Chipset containing a System-on-Chip (SOC) or a custom design Application-Specific Integrated Circuit (ASIC). The Wearable, In-Vehicle and Home Security Systems are controlled by a common Application Programming Interface (API) residing in the Cloud. Each camera video stream is analyzed by the Wearable Edge AI Chipset to detect objects, behaviors, or patterns of interest. When the required conditions are met, alerts are then triggered and sent to the user's mobile app on the cell phone for user review and display, and to his/her trusted contacts.

### CROSS-REFERENCE TO RELATED APPLICATION(S)

This application is a nonprovisional patent application, which claims priority under 35 U.S.C. § 119 (e) of the U.S. Provisional Patent Application Ser. No. 63/462,859, filed Apr. 28, 2023 and titled, “A Convertible Surround-View Video Security System,” the U.S. Provisional Patent Application Ser. No. 63/621,902, filed Jan. 17, 2024 and titled, “A UNIFIED SECURITY SYSTEM,” the U.S. Provisional Patent Application Ser. No. 63/624,204, filed Jan. 23, 2024 and titled, “A WEARABLE EDGE AI SECURITY SYSTEM,” and the U.S. Provisional Patent Application Ser. No. 63/624,211, filed Jan. 23, 2024 and titled, “A WEARABLE EDGE AI SECURITY DEVICE FOR TACTICAL APPLICATIONS,” which are hereby incorporated by reference in their entirety for all purposes.

### FIELD OF INVENTION

The present invention relates to the field of security devices and systems. More specifically, the present invention relates to the detection of objects of interest or other types of AI object signatures that are of interest that can pose either a hazard or a security threat to the user in Personal Security, Car Security, or Home Security situations.

### BACKGROUND OF INVENTION

Typical security cameras are generally designed for a particular purpose, which lacks integrated systems to be used in different locations such as in streets, at home, or inside a vehicle, and different types of security threat situation such as personal security threats, car break-ins, and home invasions.

For personal security, there is a problem of lack of personal security situational awareness for the average person walking on the street. Sometimes, a person walking on the street is approached by potentially dangerous people from behind without being aware of a stranger following them, and therefore they are unable to avoid an attack. Just in 2022 alone, there was approximately 2.4M personal assaults in the United States, an average of 2M personal assaults per month.

For automobile security, there is a rampant automobile break-in problem in the US. According to the National Insurance Crime Bureau (NICB), the number of automobile break-ins and thefts in the U.S. rose substantially during the pandemic to over 1M vehicles and has remained high ever since. Often committed by organized criminal gangs, the break-ins happen quickly, with valuable contents or the entire vehicle often stolen before the owner can respond to the car alarm. There are approximately 290M vehicles in the U.S. as of 2021. On average in the U.S., a car is stolen or broken into every 44 seconds. Few criminals that commit these crimes are ever arrested or prosecuted, and most stolen vehicles are never recovered.

Regarding home security, the FBI reports there were an estimated 900,000 home burglaries in the United States in 2021 for a total loss of $2.4B. Of these, 62.8 percent were burglaries of residential properties. The average dollar loss per burglary was $26,611.

### SUMMARY OF INVENTION

By integrating Wearable, In-Vehicle and Home Security Systems as a Service, the Unified Security Service System of the present specification provides a comprehensive security solution to users.

The embodiments of the present specification utilize different AI training models such as Convolutional Neural Networks, Recurrent Neural Networks, Generative Adversarial Networks,

Object Detection Models, and/or Segmentation Models to achieve localization and classification of objects of interest.

A Unified Security System comprises the Wearable Security System to protect individuals, In-Vehicle Security System to protect vehicles, and Home Security to protect homes. At least three systems are controlled by the system of a common Application Program Interface (API) residing in the Cloud.

In some embodiments, the Unified Video Security System utilizes proprietary Wearable Edge AI Chipset in the Wearable, In-Vehicle and Home Security Systems to perform AI analytics such as detecting faces (facial recognition), objects of interest, object behavior, behavior between objects such as collisions, specific patterns of an object, specific patterns between objects, tracking of specific objects, and others. Objects of interest includes people, faces, vehicles, animals, structures, geographic locations, or any specific programmed shapes of interest. Theses factors are able to be used to train the edge AI for better security monitoring.

The integration of Generative Artificial Intelligence (AI) and Edge AI into security systems represents the ability to monitor and respond to potential security threats in real-time, which includes the deployment of a Unified Video Security System with a Wearable Edge AI Chipset. This disclosed technology is embedded in various devices such as wearables, in-vehicle systems, and home security apparatus. One of the core functions of this chipset is to perform AI analytics, a suite of operations that includes facial recognition, object and behavior detection, and pattern recognition among objects. The implications of such a system are vast, touching on aspects of efficiency, accuracy, and adaptability in security measures.

Firstly, the ability of the system to detect faces and objects of interest such as people, vehicles, animals, structures, and geographic locations is foundational to modern security needs. This functionality allows for a nuanced understanding of the monitored environment, enabling the system to distinguish between routine and potentially threatening scenarios. For instance, the system's facial recognition capability can be used to identify known offenders or unauthorized persons in restricted areas, thereby preventing potential security breaches before they occur.

Moreover, the analysis of object behavior and interactions between objects, including collisions and specific patterns of movement, introduces an advanced layer of situational awareness. Such analytics can be crucial in scenarios ranging from traffic safety management to preemptive alerts about unusual activity within a secured premise, such as someone loitering in a restricted area for an extended period. This capability not only enhances the effectiveness of the security system but also significantly reduces the response time to potential threats.

The tracking of specific objects adds another dimension to the system's capabilities. In practical terms, this means that once an object of interest is identified, the system can maintain focus on this object across multiple cameras or sensors, ensuring continuous monitoring and gathering of relevant data. This feature is invaluable in scenarios where real-time tracking is essential, such as in the case of a stolen vehicle or a missing person within a crowded public space.

One of the compelling aspects of this Unified Video Security System is its deployment on the edge, meaning that AI analytics are performed locally on the wearable, in-vehicle, or home security device. This approach has significant advantages in terms of speed and privacy. By processing data on the device itself, the system can make immediate decisions without the latency associated with cloud computing. Furthermore, keeping sensitive data on the device mitigates privacy concerns, as personal information does not need to be transmitted or stored externally. The integration of Generative AI into security systems through the use of a proprietary Wearable Edge AI Chipset offers a paradigm shift in how security is approached. The ability to perform advanced analytics locally on a range of devices brings unparalleled efficiency and adaptability to security monitoring and response.

In some embodiments, the Wearable, In-Vehicles and Home Security Systems utilize both the Wearable Edge AI Chipset and Cloud AI analytics processing capabilities.

In an aspect, an edge AI wearable security device includes a front view camera coupled with a body of the edge AI wearable security device, a rear view camera coupled with the body pointing at a different direction from the front view camera, and a wearable edge AI processing unit in the body, wherein both the front view camera and rear view camera transmit video images to the wearable edge AI processing unit for performing AI analytics to generate alerts to a user at an occurrence of a predetermined condition.

In some embodiments, the wearable edge AI processing unit comprises an edge AI chip set. In some other embodiments, the front view camera points in a direction opposite to a direction that the rear view camera is pointing. In some other alternative embodiments, the body is structured to be worn near an ear. In some embodiments, the wearable edge AI processing unit is configured to identify the predetermined condition when a non-user is detected within a predetermined range of the user. In other embodiments, the alerts are generated when the wearable edge AI processing unit identifies a non-user is approaching the user. In some alternative embodiments, the edge AI wearable security device further comprises a communication unit configured to send an AI processed image to a smart device. In some embodiments, the smart device comprises a watch, a smart phone, or a handheld electronic device.

In another aspect, a method of providing safety monitoring comprises monitoring a user's surrounding by using a wearable smart monitoring device, identifying a predetermined safety condition from surrounding information captured by the wearable smart monitoring device, and generating a notification to the user at an occurrence of the predetermined condition.

In some embodiments, the wearable smart monitoring device comprises at least two cameras pointing at two different directions. In other embodiments, the surrounding information comprise a real-time audio, a real-time image, or both. In some alternative embodiments, the method further comprises processing the real-time audio, the real-time image, or both by using an edge AI embedded chip set in the wearable smart monitoring device. In some embodiments, the method further comprises generating an edge AI processed safety information. In other alternative embodiments, the method further comprises transmitting the edge AI processed safety information to a smart device. In some alternative embodiments, the smart device comprises a smart watch, a smart phone, or a display of a personal electronic device. In some embodiments, the predetermined condition comprises an identified object of interest. In some other embodiments, the identified object of interest comprises one or more people, faces, vehicles, animals, structures, or geographic locations. In some alternative embodiments, the predetermined condition comprises an identified behavior of interest. In some embodiments, the identified behavior of interest comprises a person or animal acting erratically or starting to run, a person or object approaching a user rapidly, or a person or object approaching a user from behind.

In another aspect, a property safety monitoring system comprises a portable property monitoring device having at least two edge AI embedded cameras, an edge AI processing unit configured to identify a safety concern condition of a property and generate an AI processed safety information, and a communication system configured to transmit the AI processed safety information to a remote receiving device.

In some embodiments, the portable property monitoring device is configured to monitor the surroundings of an auto vehicle. In some other embodiments, the portable property monitoring device is configured to monitor the surroundings of a building. In some alternative embodiments, the portable property monitoring device comprises a rearview mirror in-vehicle device mount. In other alternative embodiments, the property safety monitoring system further comprises a front driver side camera configured to monitor a condition of a driver and a front passenger sider camera configured to monitor a condition of a passenger. In some other alternative embodiments, the property safety monitoring system further comprises a rear cabin camera configured to monitor a condition of a rear seat passenger. In some embodiments, the AI processed safety information is transmitted to cloud storage. In other alternative embodiments, the AI processed safety information is transmitted from the cloud storage to a smart device. In some embodiments, the wearable device comprises a smart phone. In other alternative embodiments, the AI processed safety information is transmitted from the cloud storage to a display of a wearable device. In some other alternative embodiments, the AI processed safety information is transmitted from the cloud storage to a Network Operation Center to be transmitted to a public network.

Other features and advantages of the present invention will become apparent after reviewing the detailed description of the embodiments set forth below.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIG. 1 illustrates a Wearable Security Device with front and rear facing cameras as part of the Wearable Security System embedded with an AI Chipset in accordance with some embodiments.

FIG. 2 illustrates Wearable Security Device with front and rear facing cameras as part of Wearable Security System embedded with an AI Chipset in accordance with some embodiments.

FIG. 3A illustrates a scene where a potential attacker is approaching a female jogger from behind who is wearing a Wearable Security Device in accordance with some embodiments.

FIG. 3B illustrates a scene where the female jogger is alerted by the Security Device and sees the potential attacker from behind on her video watch (or a Smartphone App) in accordance with some embodiments.

FIG. 3C illustrates a scene where the Wearable Security Device dials 911 immediately or connects to the Network Operations Center (NOC) for emergency contact by the User either pressing on the Power/Control Button in a sustained duration, or by voice command “911” or “Command Center” as displayed on her Smartwatch in accordance with some embodiments.

FIG. 3D illustrates a scene where the female jogger once alerted by Wearable Security Device can quickly distance herself from the potential attacker while maintaining visual contact with him in accordance with some embodiments.

FIG. 4A illustrates a scene where a young child is walking to school followed by a stranger in the distance that can be warned by the device in accordance with some embodiments.

FIG. 4B illustrates a Trip Report displaying the images of locations where the young child has been traveling on the way to school: the playground, the bus stop, and finally the school that can be warmed by the device of potential danger in accordance with some embodiments.

FIG. 4C illustrates a scene of a concerned parent checking in on and seeing in real-time where her young child is and where he has been by viewing her Smartphone App in accordance with some embodiments.

FIG. 5 illustrates the data flow block diagram of the Wearable Security Device as part of Wearable Security System in accordance with some embodiments.

FIG. 6A-6C illustrate the In-Vehicle Camera and AI Gateway Device as part of the In-Vehicle Security System embedded with a Proprietary AI Chipset installed into a vehicle in accordance with some embodiments.

FIG. 6D illustrates the In-Vehicle Camera and AI Gateway Device as part of the In-Vehicle

Security System embedded with a Proprietary AI Chipset in an alternative single Dashcam device design so that warning can be generated in accordance with some embodiments.

FIG. 6E illustrates a scene where a potential car thief is approaching a vehicle installed with an In-Vehicle Security Device so that warning can be generated in accordance with some embodiments.

FIG. 6F illustrates a scene where a potential car thief is approaching the vehicle and a female driver is sitting inside in accordance with some embodiments.

FIG. 6G illustrates a scene where the driver receives a video alert on the Smartphone App displaying an approaching thief in accordance with some embodiments.

FIG. 6H illustrates a scene where a vehicle installed with the In-Vehicle Security System triggers the AI Gateway Device warning alert when a potential thief approaches too close to the vehicle in accordance with some embodiments.

FIG. 7A illustrates a scene where a vehicle installed with the In-Vehicle Security System with a female driver sitting in the driver's seat is hit by an approaching vehicle in accordance with some embodiments.

FIG. 7B illustrates a scene where the vehicle with the female driver sitting in the driver's seat is damaged by a hit-and-run vehicle so the In-Vehicle Security System automatically records the accident in accordance with some embodiments.

FIG. 7C illustrates a scene where the damaged vehicle installed with the In-Vehicle Security System to automatically records the accident and captures the hit-and-run vehicle's license plate in accordance with some embodiments.

FIG. 7D illustrates a scene where the damaged vehicle installed with the In-Vehicle Security System displaying various video image records of the accident in accordance with some embodiments.

FIG. 8 illustrates the data flow block diagram of the In-Vehicle Security System in accordance with some embodiments.

FIG. 9A illustrates that the In-Vehicle Camera and AI Gateway System can be easily adapted into a Home Security System or other existing Home Security System in accordance with some embodiments.

FIG. 9B illustrates a scene where the homeowner receives a video alert on the Smartphone App displaying a stranger walking in her backyard in accordance with some embodiments.

FIG. 9C illustrates different scenes where the homeowner receives different video alerts around her property in accordance with some embodiments.

FIG. 9D illustrates the integration of the Wearable Security System with the homeowner's daughter wearing the Wearable Security Device playing in front of the home with the In-Vehicle System view of the exterior passenger side of the vehicle in accordance with some embodiments.

FIG. 9E illustrates the displaying of video images from the integration of Home Security System with Wearable Security System and In-Vehicle Security System by the means of an Application Programming Interface (API) residing in the Cloud in accordance with some embodiments.

FIG. 10A illustrates the data flow block diagram between the Cloud and the Home Security System, In-Vehicle Security System and Wearable Security System in accordance with some embodiments.

FIG. 10B illustrates the API command flow block diagram between the Cloud and the Home Security System, In-Vehicle Security System and Wearable Security System APIs in accordance with some embodiments.

FIG. 10C illustrates the API command flow block diagram without the Cloud. In its place, the Home Security System Gateway Device API communicates with the In-Vehicle Security System and Wearable Security System APIs in accordance with some embodiments.

FIG. 11 illustrates another view of the API residing in the Cloud controlling the Home Security System, In-Vehicle Security System and Wearable Security System APIs in accordance with some embodiments.

FIG. 12 illustrates the API residing in the Cloud is no longer available or used to control the Home Security System, In-Vehicle Security System and Wearable Security System. The API control has switched over to the Local Gateway Device of the Home Security System in accordance with some embodiments.

FIG. 13 illustrates the API command flow via the Internet-of-Things (IOT) Stack containing 3 major blocks 1) IoT Security Sensors 2) IoT Gateways 3) Cloud comprising the Cloud API and Server Farm in accordance with some embodiments.

FIG. 14 illustrates the API command flow via the Internet-of-Things (IOT) Stack containing 2 major blocks 1) IoT Security Sensors 2) IoT Gateways in accordance, and without Cloud comprising of the Cloud API and Server Farm in accordance with some embodiments.

FIG. 15 is a flowchart illustrating a method of providing safety monitoring in accordance with some embodiments.

### DETAILED DESCRIPTION OF THE PREFERRED EMBODIMENT

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications, and equivalents, which can be included within the spirit and scope of the invention as defined by the appended claims. Furthermore, in the following detailed description of the present invention, numerous specific details are set forth to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made to achieve the developer's specific goals, such as compliance with application and business-related constraints, and that these specific goals vary from one implementation to another and from one developer to another. Moreover, it is appreciated that such a development effort can be complex and time-consuming but is nevertheless a routine undertaking of engineering for those of ordinary skill in the art having the benefit of this disclosure.

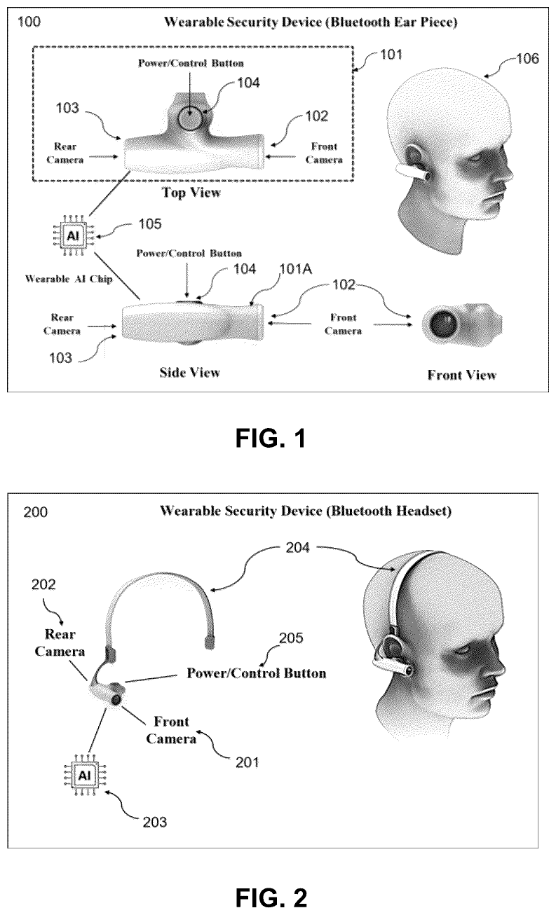

FIG. 1 illustrates a Wearable Security Device 100 in accordance with some embodiments. In some embodiments, the construction of the wearable security device 100 comprises an earbud 101 having a body 101A. In some embodiments, the earbud 101 contains a Bluetooth and/or WIFI communication module, and a Wearable AI Chipset 105. A person of ordinary skill in the art appreciates that any other communication modules are within the scope of the present disclosure, such as WIFI, cellular and infrared communications modules.

In some embodiments, the earbud 101 contains a power/control button 104 to enable power to the Wearable Security Device 101. By the number of button presses, or the duration of the button press, the power to the Wearable Security Device is turned ON/OFF, or a phone call is connected/disconnected, or music is played/stopped.

In some embodiments, the body 101A contains one or more front facing Cameras 102 and one or more rear facing Cameras 103. A person of ordinary skill in the art appreciates that the Cameras can be constructed or configured to be pointed to any other direction with various numbers of cameras.

In some embodiments, the Cameras are embedded with a Proprietary Wearable Edge AI Chipset in order to perform AI analytics to detect objects of interest such as people, faces, vehicles, animals, structures, geographic locations, or any specific programmed objects of interest, including object behavior, behavior between objects such as collisions, specific patterns of an object, specific patterns between objects, tracking of specific objects, and any other designed in AI analytics requirements in order to generate alerts and send to the user when a predetermined event/condition is met.

In some embodiments, the Wearable Edge AI Chipset detects a predetermined event/condition or a person, a face, a vehicle, an animal, or an object of interest is approaching for example from behind, then an audible or video user alert will be generated.

In some embodiments, Edge AI Chipset disclosed herein includes the use of artificial intelligence algorithms on edge devices, which are computing devices located at or near the source of data generation, such as cameras, smartphones, and IoT (Internet of Things) devices. This approach enables real-time data processing without the need to send data back to a centralized server or cloud, significantly reducing latency, bandwidth usage, and dependency on constant internet connectivity. When it comes to image processing, Edge AI Chipset can perform a wide range of tasks, including:

Real-time Object Detection and Tracking: Edge AI can identify and track objects in real-time from video feeds or images captured by edge devices. This capability is crucial for applications such as security surveillance, traffic management, and autonomous vehicles.

Image Classification: Edge AI can classify images into predefined categories on the device itself. This feature is beneficial for organizing photo libraries, content moderation, and retail analytics.

Facial Recognition: Edge AI enables the recognition of individual faces for security systems, personalized experiences in retail, or attendance systems in workplaces or schools, ensuring privacy and data security by processing data locally.

Augmented Reality (AR): Edge AI supports AR applications by allowing edge devices to recognize objects, surfaces, or locations and overlay digital information in real-time, enhancing user experiences in gaming, navigation, and education.

Health Monitoring: In healthcare, Edge AI can process images from medical devices or wearables to monitor health conditions, detect abnormalities, and provide immediate feedback or alerts.

Gesture Recognition: Edge AI enables devices to recognize and interpret human gestures as commands, enhancing user interaction with devices in smart homes, gaming, and interactive installations.

The Edge AI can reduce the data processing in a remote location reducing the needed response time.

In some embodiments, the user alerts are able to be sent to the user 106 himself/herself or trusted contacts.

In some embodiments, the user alerts contain still images and video recordings, date, time, and GPS locations.

In some embodiments, the user alerts are sent to the user's Smartphone App, and/or Smartwatch, and/or trusted contacts, and/or Network Operations Center (NOC). Users may pay monthly subscription cost for this service.

In some embodiments, a user 106 utilizes his/her cell phone or hands-free voice command to call 911 or to alert a trusted contact.

In some embodiments, a user designated emergency contact(s) can remotely view a live-view from user's wearable video security camera 100.

In some embodiments, a user records video trip reports for additional functionality.

In some embodiments, under normal operating conditions when an alert has not been triggered, the wearable video device operates as a standard Bluetooth and/or WIFI Headset or Earbud connecting to a cellular phone for voice calls or music.

FIG. 2 illustrates another Wearable Security Device 200 in accordance with some embodiments.

In some embodiments, the Wearable Security Device 200 contains a front 201 and rear 202 facing camera. The device 200 utilizes a Wearable AI Chipset 203 to detect objects approaching the user from the cameras, thus providing the user with increased situational awareness by alerting him or her of an object approaching for example from behind.

In some embodiments, the Wearable Security Device 200 is connected to a Smartphone App, or a smartwatch by the means of Bluetooth or WIFI communications to transmit video images for display onto the smartphone or smartwatch.

In some embodiments, the Wearable Security Device 200 contains a headset wearing device 204, such as a headband.

In some embodiments, the Wearable Security Device 200 can be attached to other parts of the body by a means of a wearable mounting device such as for head, shoulder, arms, or waist attachment use.

In some embodiments, the Wearable Security Device 200 contains a power/control button 205. By the number of button presses, or the duration of the button press, the power to the Wearable Security Device is turned ON/OFF, or a phone call is connected/disconnected, or music is played or stopped.

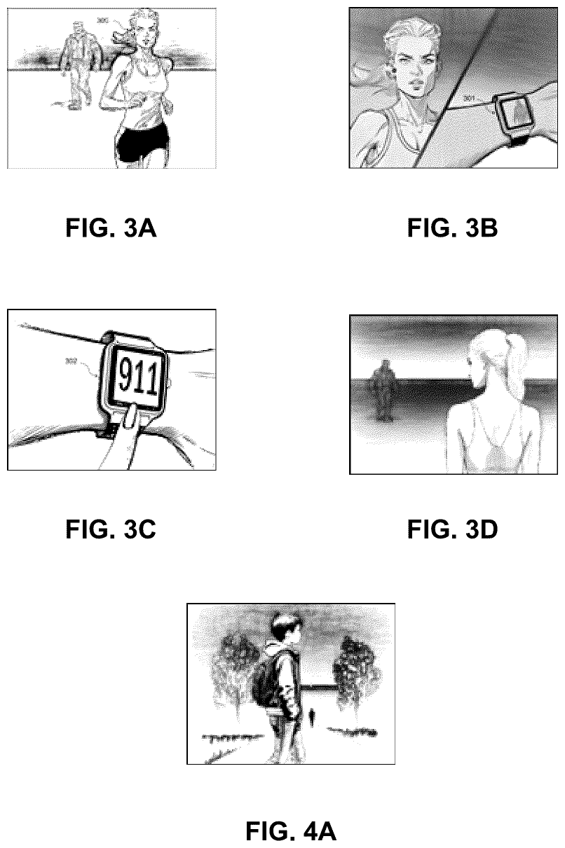

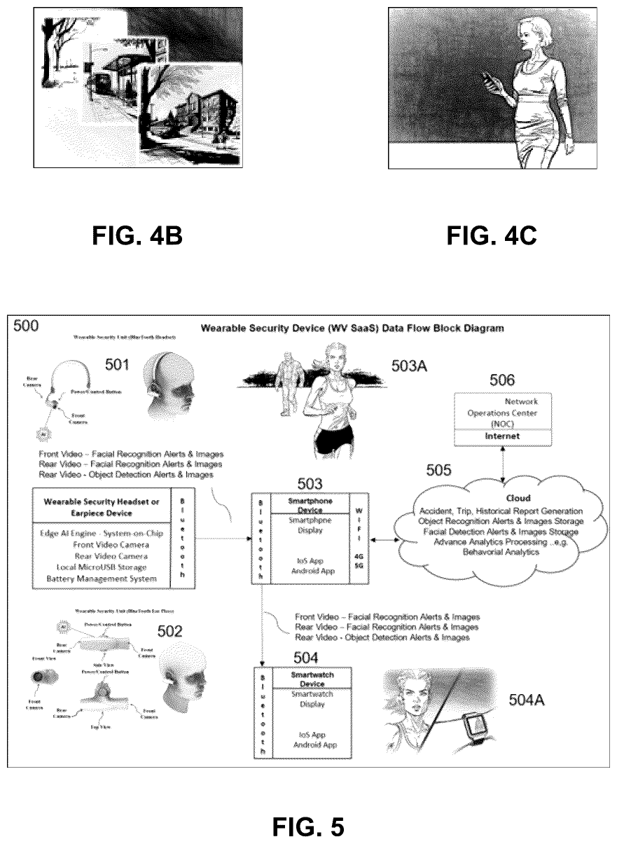

In the following, FIGS. 3A-3D and 4A-4C illustrate the uses of the wearable edge AI security systems.

FIG. 3A illustrates a female jogger wearing the Wearable Security Device 300 embedded a front and rear facing camera with an embedded Wearable Edge AI Chipset (e.g., edge computing on the device) as part of the Wearable Security System with a stranger following from behind.

FIG. 3B illustrates the female jogger wearing the Wearable Security Device 300 detecting the stranger following from behind and displaying the image of the stranger on her Smartwatch display 301. The detection can be done by the AI image analysis and identification function to detect the stranger or any other predetermined conditions.

FIG. 3C illustrates the female jogger wearing the Wearable Security Device 300 detecting the stranger following from behind. The Wearable Security Device dials 911 immediately or connects to Network Operations Center (NOC) for emergency contact by the jogger either pressing on the Power/Control Button in a sustained duration, or by voice command “911” or “Command Center” as displayed on her Smartwatch 302.

FIG. 3D illustrates the female jogger alerted by Wearable Security Device while immediately notifying 911, she quickly distances herself from the potential attacker while maintaining visual contact with him thus thwarting a potential attack on her.

FIGS. 4A-4C illustrate the use of the Wearable Security Device as part of the Wearable Security System. The scenes illustrate a young child walking to school followed by a stranger in the distance. A Trip Report displaying snapshots configured for every 5, 10 or 15 seconds, for example, (user configurable) of the images of locations where the young child has been traveling on the way to school, the playground, the streetcar stops, and finally at the school. Meanwhile, the concerned parent is checking on and seeing in real-time where her young child is, where he has been, and if the stranger is still following her child using her Smartphone App.

FIG. 5 illustrates the data flow block diagram of the Wearable Security System 500 having a

Wearable Security Device (Blue Tooth Headset) 501, Wearable Security Device (Blue Tooth Ear Piece) 502 with both having an embedded Proprietary AI Chipset, Smartphone Device 503, Smartwatch Device 504, Cloud 505, Network Operations Center (NOC) 506.

In some embodiments, the Wearable Security Devices 501 and 502 send front and rear camera video alerts and images detected by the embedded AI Chipset to the user's Smartphone Device App 503 by means of Bluetooth communications. The processed alerts and images can be displayed on the Smartphone Display 503/503A or on a Smartwatch Device Display 504/504A. The alerts and images are also sent to the Cloud 505 for further accident, trip, or historical report generation, or for Cloud Storage of alerts and images, or advance analytics processing. The Network Operations Center (NOC) 506 also utilizes the processed alerts and images for emergency contact management information when communicating with the user, trusted contacts, or emergency contacts. Users may pay monthly subscription cost for this service. In some embodiments, the system throughout this disclosure also uses a smart power management system that dynamically adjusts the sampling rate based on the power consumption of the computing power needed by the device.

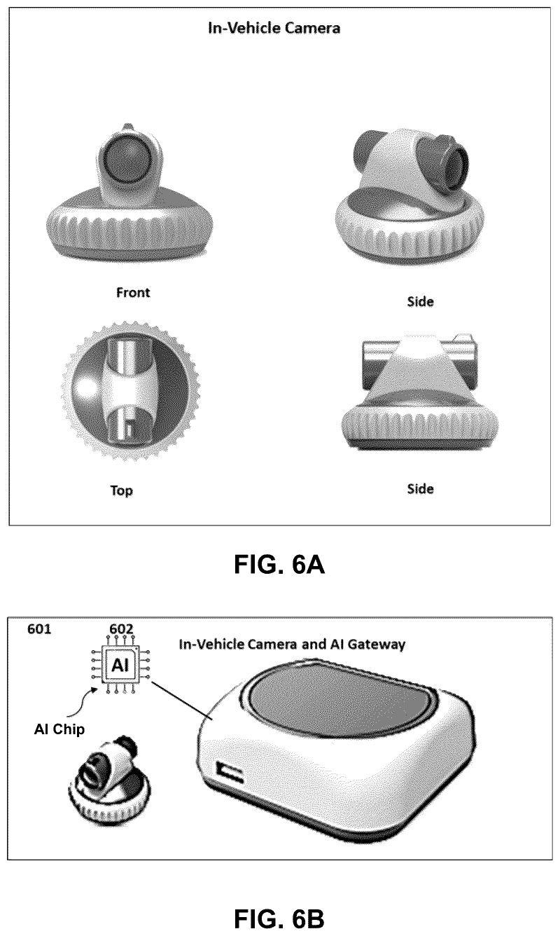

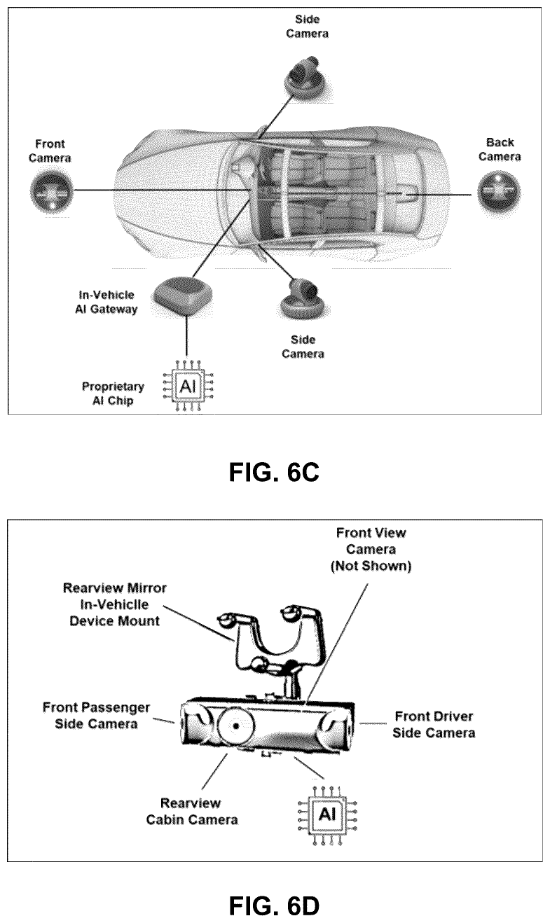

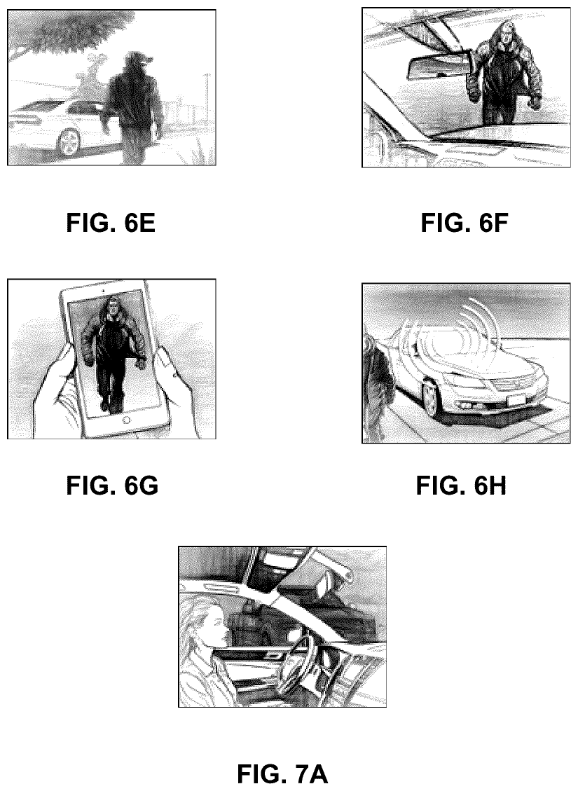

FIG. 6A illustrates different views of an In-Vehicle Camera 600 which is battery-powered, or can be directly powered by the AI Gateway Device 601 (FIG. 6B) by the means of a USB cable which also serves a direct-connect communications method in accordance with some embodiments. The camera can also communicate wirelessly with the AI Gateway Device 601 by means of Bluetooth or WIFI communications. An independent DC power source can also be connected to the Camera and AI Gateway when it is configured in such a way.

FIG. 6B illustrates the In-Vehicle Security System containing an In-Vehicle Camera 600 paired with the AI Gateway Device 601 embedded with an AI Chipset 602 in the AI Gateway Device 601 in accordance with some embodiments.

For the purpose of simplicity FIG. 6B only shows a single USB port. The AI Gateway can also communicate with the Cloud by means of a cellular uplink or WIFI Local Area Network (LAN) in the AI Gateway when available. The user is able to view the camera video streams, alerts and images generated by the AI Chipset 602 in the AI Gateway Device and display them by means of the mobile App on a Smartphone or Smartwatch or Smart Tablet.

FIG. 6C illustrates the AI Gateway supporting up to four or more In-Vehicle Cameras 603 depending on configuration in accordance with some embodiments.

FIG. 6D illustrates four In-Vehicle Cameras and the AI Gateway integrated into a single Dashcam Device 604 in accordance with some embodiments. The single Dashcam Device 604 can contain a rearview mirror in-vehicle device mount 606, a front camera 608, a front passenger side camera 610, a rearview cabin camera 612, embedded AI Edge chip set 614, and a front driver side camera 618. The rearview mirror in-vehicle device mount 606 is able to mount the Dashcam Device 604 on to the rearview mirror of the vehicle. The front passenger side camera 610 and front driver side camera 618 are able to capture/record the videos on the front passenger side and the front driver side respectively. The rearview cabin camera 612 is able to capture/record the videos of the rear cabin. The front camera 608 is able to capture/record the videos of the road conditions and the views of the driver.

FIGS. 6E-6H illustrate when the vehicle is parked the In-Vehicle Security System automatically enters Parking Mode which enables security features, such as sending an alert to the user when someone gets too close to, looks in to, or breaks in to the vehicle in accordance with some embodiments.

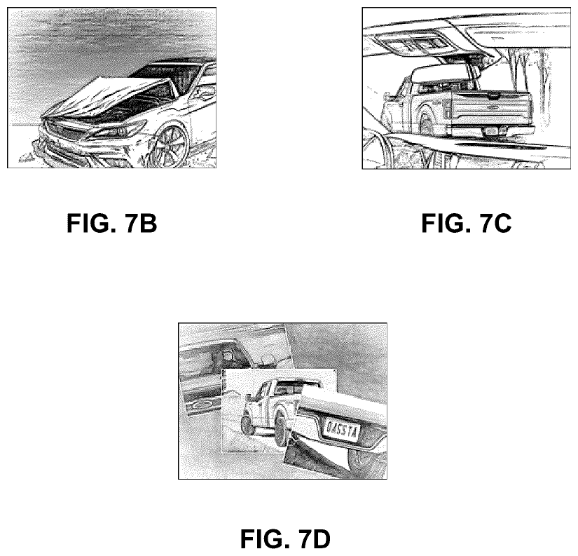

FIGS. 7A-7D illustrate when the vehicle is moving in Driving Mode, the In-Vehicle Security System besides recording inside and outside of camera views, it is also enabled for Accident Mode in accordance with some embodiments. When there is a sudden impact to the vehicle, the In-Vehicle Security System will create an incident/accident report by starting to capture (5, 10, 15 seconds . . . e.g., user configurable) video and record the Time, Date, GPS Location, Location Map, and all camera views before the incident, and for (5, 10, 15 minutes . . . e.g., user configurable) after the incident. The incident/accident report is stored locally on the AI Gateway Device and uploaded to the cloud if the Cellular uplink or a WIFI Local Area Network (LAN) is available.

In some embodiments, each camera captures a 160 degree field of view, and is positioned in such a way that a set of four cameras will provide a complete surround-view from inside a vehicle.

In some embodiments, up to four additional cameras can be added to increase more interior/exterior views of the vehicle for a total of eight cameras. The In-Vehicle Security System utilizes Wearable Edge AI Chipset to detect objects of interest from all the camera video streams, and then sends the alerts to the user when a trigger condition is met, such as a person looking in to or breaking in to the vehicle.

In some embodiments, the In-Vehicle Security System has a Parking Mode (FIGS. 6E-6H) and a Driving Mode (FIGS. 7A-7D). When in the driving mode, the In-Vehicle Security System acts as a multi-view dashcam with continuous recording. When the vehicle is stopped/parked, the In-Vehicle Security System automatically switches to Parking Mode, which provides the following features: 1) alerts the user when Wearable Edge AI Chipset detects someone getting too close to, looking in to, or breaking into the vehicle. User contact(s) are sent snapshots and/or video recordings, time, date stamp, and GPS location; 2) user can live-view in to their vehicle for exterior or interior views depending on camera locations; 3) user can activate a pre-recorded message from the vehicle notifying the perpetrator that they are being watched and recorded and need to move away, and 4) user can talk directly to the vehicle (with their voice projected from a speaker on the vehicle). In case of a hit-and-run accident, an automatic accident report is generated with snapshots and/or video recordings, time, date stamp, GPS location, and license plate of the hit-and-run vehicle if sufficiently visible for the police to quickly track down the hit-and-run vehicle, and its driver.

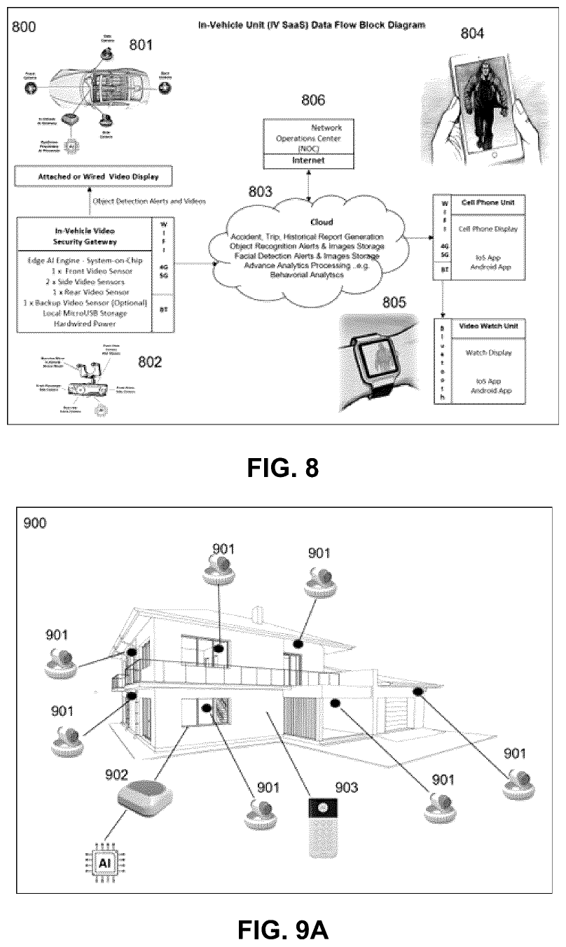

FIG. 8 illustrates the data flow block diagram 800 of the In-Vehicle Security System containing four In-Vehicle Cameras paired with the AI Gateway Device embedded a Proprietary AI Chipset 801, or in a single Dashcam Device 802, Smartphone Device 803, Smartwatch Device 804, Cloud 805, Network Operations Center (NOC) 806 in accordance with some embodiments.

In some embodiments, the In-Vehicle Security System 800 sends video alerts and images detected by the embedded AI Chipset to the user's Smartphone Device App 803 by using Bluetooth or WIFI communications, or locally within the Dashcam Device 802 if installed instead of the separate AI Gateway Device 801. The processed alerts and images are then sent and displayed on the Smartphone Display 804, or on a Smartwatch Device Display 805. The alerts and images can also be further sent to the Cloud 803 for further analysis such as accident, trip, or historical report generation, or for cloud storage of alerts and images, or advance analytics processing such as behavioral analytics and object tracking. The Network Operations Center (NOC) 806 can also process the alerts and images for emergency contact management information when communicating with the user, trusted contacts, or emergency contacts. Users may pay a monthly subscription for this service.

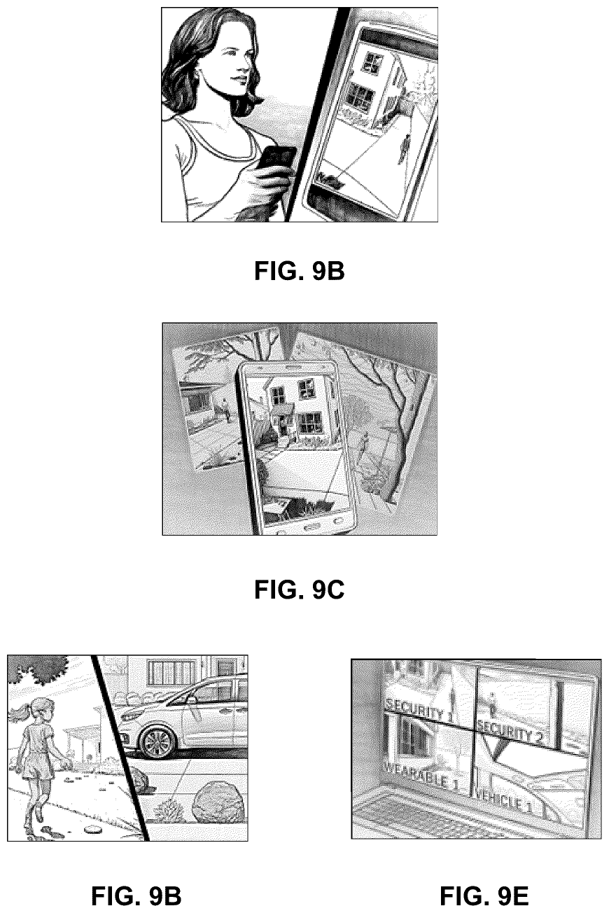

FIG. 9A illustrates the In-Vehicle Cameras and AI Gateway System easily adapted into a Home Security System 900 or with other existing Home Security System in accordance with some embodiments. The Cameras and Wearable Edge AI Chipset Gateway can be either battery-powered or connected to AC or DC power. In this illustration, the Home Security System contains Cameras 901, Wearable Edge AI Chipset Gateway 902, Alarm System Handheld Remote Control 903. In some embodiments, the Home Security System can be controlled and interoperate with the Wearable Security System and In-Vehicle Security System by means of an Application Programming Interface (API) residing in the Cloud. The API can also enable other security devices and systems to interoperate with the Systems such as interior/exterior cameras, doorbell cameras, motion sensors, door and window sensors, glass break sensors, smart door locks, fire, smoke, and carbon dioxide sensors, home automation systems, and other existing video or access control security systems.

FIGS. 9B-9E illustrate scenes of 1) a homeowner receiving a video alert on the Smartphone App displaying a stranger walking in her backyard (FIG. 9B); 2) the homeowner receives different video alerts around her property (FIG. 9C); 3) the integration of the Wearable Security System with the homeowner's daughter wearing the Wearable Security Device playing in front of the home, and with the In-Vehicle Security System view of the side walk outside of the parked vehicle at home owner's driveway (FIG. 9D); 4) the displaying of video images from the integration of Home Security System with Wearable Security and In-Vehicle Security System on a computer browser display by the means of an Application Programming Interface (API) communicating between the devices within each systems and the Cloud in accordance with some embodiments (FIG. 9E).

In some embodiments, a homeowner using the Mobile App can monitor the safety of their child as he or she goes about his/her daily activities, or monitor the safety of their vehicles or home on single App. The homeowner will be notified when an alert is triggered. The homeowner can then seek help immediately from the police (911) or the Network Operations Center (NOC). All alert data will be stored locally on each device and on the Cloud if the homeowner subscribes to Cloud Storage. Users may pay a monthly subscription for this service.

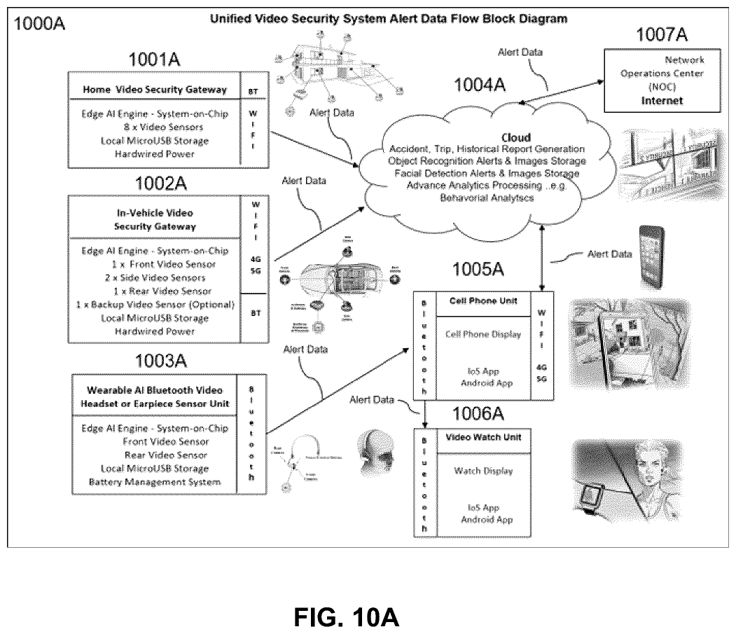

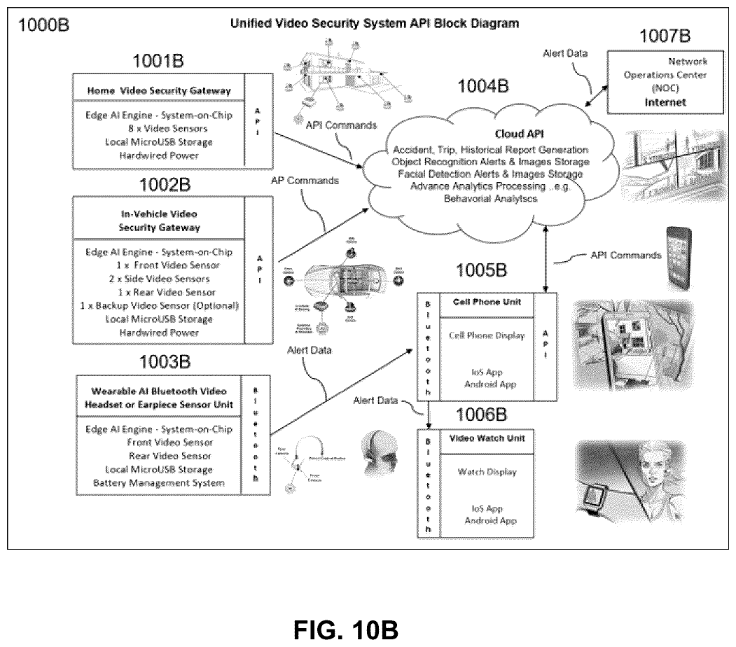

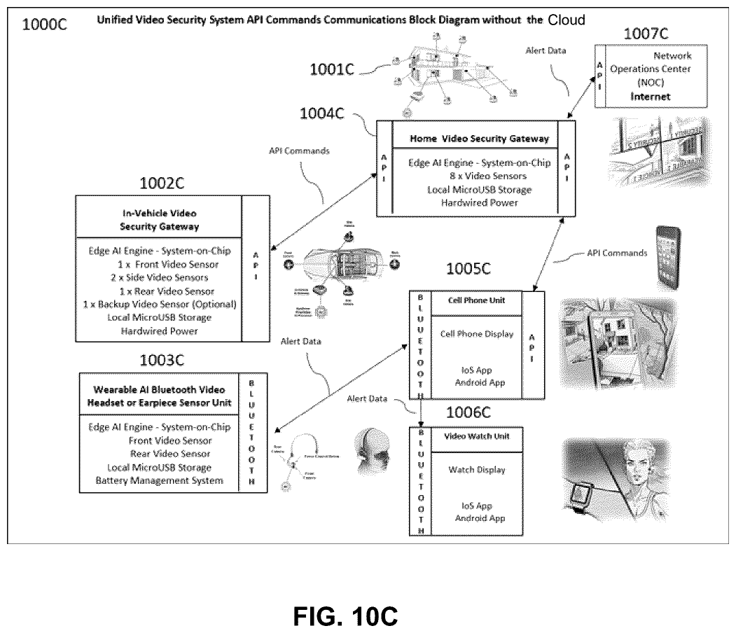

FIG. 10A illustrates the data flow block diagram between the Unified Video Security System 1000A containing 1) Home Security System 1001A, 2) In-Vehicle Security System 1002A, and 3) Wearable Security System 1003A. All alert data generated by the Wearable Edge AI Chipset from the devices are displayed and stored locally on each system.

The Home Security System 1001A and In-Vehicle Security System 1002A can transmit Alert Data to the Cloud by the means of cellular uplink, or WIFI to the Cloud 1004A for storage and for more advance data analytics applications.

However, the Wearable Security System 1003A devices such as Bluetooth Headset, or Bluetooth Earpiece, or any other embedded Wearable Edge AI Chipset device transmit Alert Data to the Smartphone 1005A then to the Smartwatch 1006A for image or video display, and basic local analytics processing before sending Alert Data to the Cloud 1004A for storage or Advance Analytics processing by the means of a cellular uplink or WIFI network.

The Alert Data is sent to the Cloud 1004A for further analysis for accident, trip, or historical report generation, application automation or for Cloud Storage of alerts and images, or advance analytics processing such as object behavior and object tracking. The Network Operations Center (NOC) 1007A can also utilize processed alerts and images for emergency contact management information when communicating with the user, trusted contacts, or emergency contacts. Users may pay a monthly subscription for this service.

FIG. 10B illustrates the Unified Security System block diagram with the API residing in the Cloud 1004B of the Unified Video Security System 1000B controlling 1) Home Security System 1001B, 2) In-Vehicle Security System 1002B, and 3) Wearable Security System 1003B. All alert data generated by the Wearable Edge AI Chipset from the devices are displayed and stored locally by each system, and can be controlled by the Cloud API 1004B by means of API requests and responses between the devices and the Cloud API 1004B.

The Home Security System 1001B and In-Vehicle Security System 1002B communicate directly to the Cloud API 1004B by means of a cellular uplink or WIFI network. The Alert Data can also be sent to the Cloud API 1004A for further analysis such as accident, trip, or historical report generation, application automation or for Cloud Storage management of Alerts and Images, or Advance Analytics processing such as object behavior and object tracking. The Cloud API 1004B is also directly interfaced with the Network Operations Center (NOC) 1007B. Users may pay a monthly subscription for this service.

FIG. 10C illustrates the Unified Security System block diagram with the API residing in the Home Security Gateway 1004C of the Unified Video Security System 1000C controlling 1) Home Security System 1001C, 2) In-Vehicle Security System 1002C, and 3) Wearable Security System 1003C. All alert data generated by the Wearable Edge AI Chipset from the devices are displayed and stored locally by each system and can be controlled by the Home Security Gateway API 1004C by means of API requests and responses between the In-Vehicle Gateway API and the Wearable Mobile APP API installed in User's Cell Phone Unit 1004C.

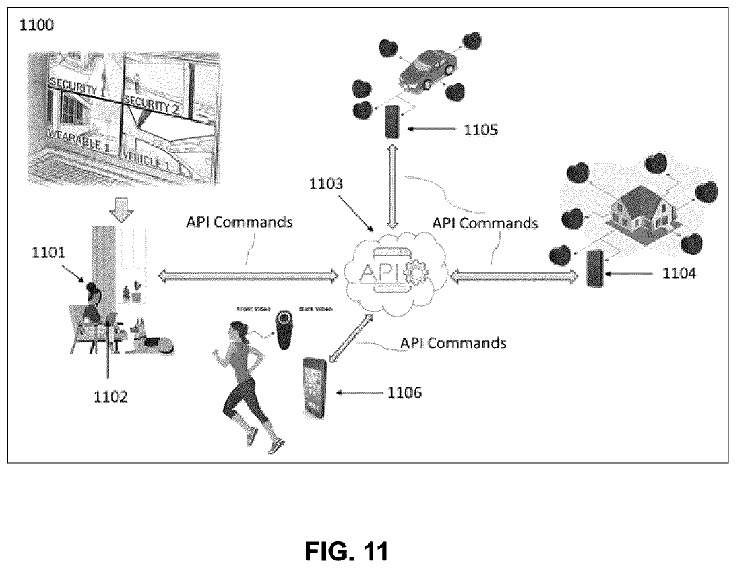

FIG. 11 illustrates a user 1102 using an approved browser from his/her computer 1102 logging into the Cloud API 1103 to view and manage his/her Unified Video Security System 1100 by sending API messages to and from 1) Home Security System Gateway 1104, 2) In-Vehicle Security System Gateway API 1105, and 3) Wearable Security System Mobile App API on user's smartphone 11106 in accordance with some embodiments.

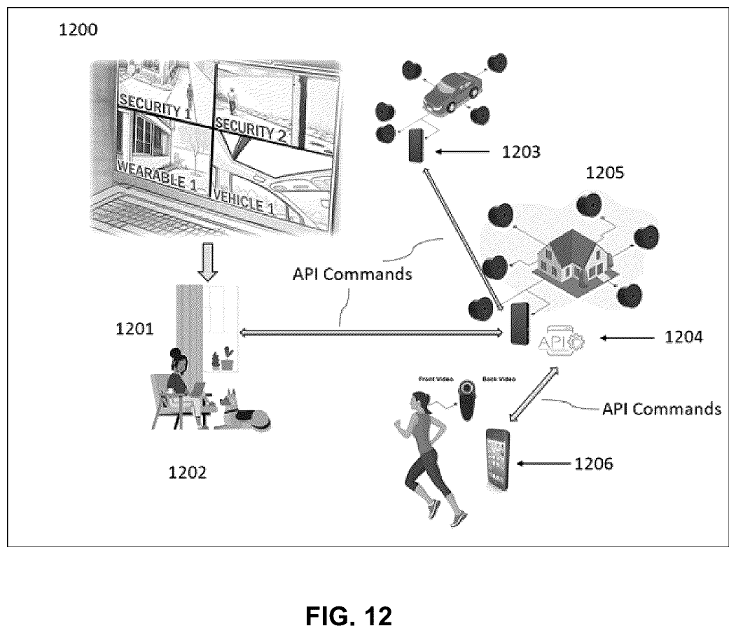

FIG. 12 illustrates the API residing in the Home Security System Gateway 1204 instead, and the Cloud API is no longer available to control 1) the Home Security System 1205, 2) the In-Vehicle Security System 1203, and 3) the Wearable Security System 1206. The API control is defaulted to the In-Vehicle Gateway Device API 1204 of the Home Security System 1205 in accordance with some embodiments.

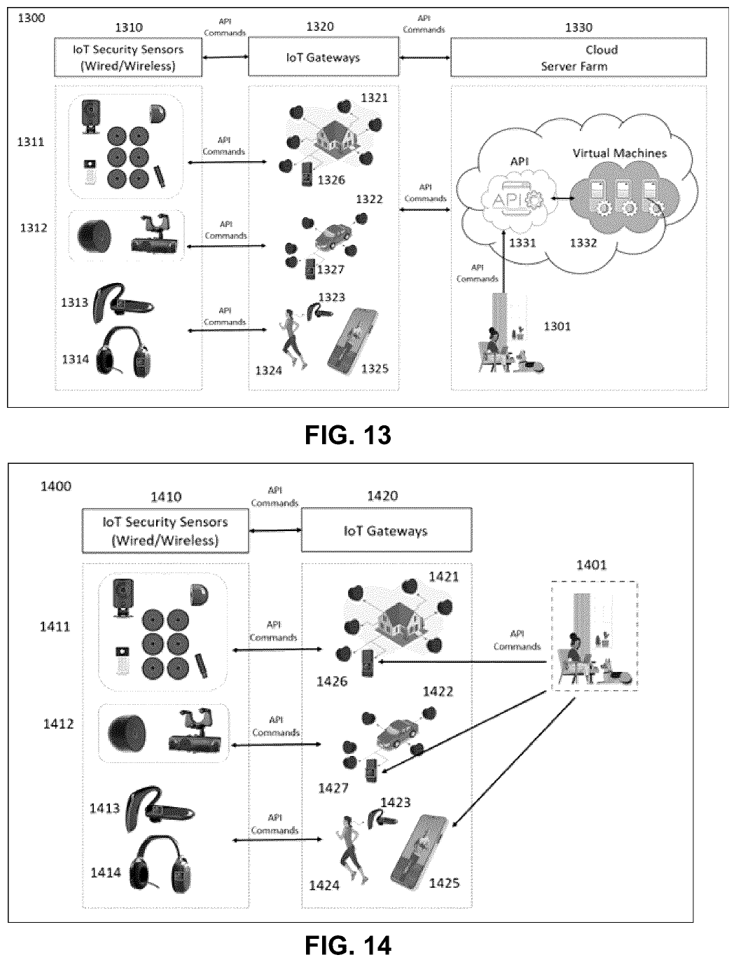

FIG. 13 illustrates the API command flow via the Internet-of-Things (IoT) Stack 1300 comprising the IoT Security Sensor Block 1310 which contains 1) Home Security System Devices 1311 which can include interior/exterior cameras, doorbell cameras, motion sensors, door and window sensors, glass break sensors, smart door locks, fire, smoke, and carbon dioxide sensors, home automation systems, and other existing video or access control security systems, 2) In-Vehicle Security System Devices 1312 comprising wireless cameras and/or dashcam, 3) Wearable Security System security devices comprising video security earpiece 1313 or headset 1314.

The next block is the IoT Gateway Block 1320 comprising 1) Home Security System 1321 2) In-Vehicle Security System 1322 3) Wearable Security System 1323 which is comprise of a Wearable Security Device 1324 communicating with the User's Mobile APP installed on his/her smart phone 1325. The smart phone then communicates with the next block.

Th next block is the Cloud Server Farm 1330 comprising the API 1331 to which the User 1301 sends API Commands to control the Home Security System, the In-Vehicle Security System, and the Wearable Security System. The Virtual Machines 1332 provide the cloud analytics computing capability, and user data storage.

The User 1301 connects to the API 1331 either by approved browser, or by the mobile App. The API 1331 then forwards API commands to the 1) Home Security System Gateway 1326 2) In-Vehicle Security System Gateway 1327 3) Wearable Security System user smart phone 1325 which then sends API commands to the Wearable Devices 1313, and 1314.

FIG. 14 illustrates the API command flow via the Internet-of-Things (IOT) Stack 1400 comprising the IoT Security Sensor Block 1410 which contains 1) Home Security System Devices 1411 which can include interior/exterior cameras, doorbell cameras, motion sensors, door and window sensors, glass break sensors, smart door locks, fire, smoke, and carbon dioxide sensors, home automation systems, and other existing video or access control security systems, 2) In-Vehicle Security System Devices 1412 comprising wireless cameras and/or dashcam, 3) Wearable Security System security devices comprising video security earpiece 1413 or headset 1414.

The next block is the IoT Gateway Block 1420 comprising 1) Home Security System 1421 2) In-Vehicle Security System 1422 3) Wearable Security System 1423 which is comprise of a Wearable Security Device 1424 communicating with the User's Mobile App installed on his/her smart phone 1425. The smart phone Mobile App then communicates with the user 1401 directly since the Cloud API and Server Farm is not available. The API Commands are sent directly from the user 1401 to the Home Security System Gateway 1426, the In-Vehicle Security System Gateway 1427, and the Wearable Security System devices 1413 and 1414.

For each device disclosed herein, a wearable security system contains an API. For each AI Gateway disclosed herein, a car security system contains an API. For each AI Gateway disclosed herein, a home security system contains an API. The different security systems interoperate by communicating with a common Application Programming Interface (API) between the devices within each system and the Cloud.

In some embodiments, a system comprising two or more low power high resolution Cameras width 15 mm or less lens diameter transmitting video stream to a Wearable Edge AI Chipset either a System-On-Chip (SOC) with node size of 12 nm or less or an Application-Specific-Integrated-Circuit (ASIC) chipset with node size of 12 nm or less for edge analytics processing.

The system further comprises two or more low power high resolution endoscopic cameras transmitting video data to a Wearable Edge AI Chipset either a System-On-Chip (SOC) with node size of 12 nm or less or an Application-Specific-Integrated-Circuit (ASIC) chipset with node size of 12 nm or less for edge analytics processing.

The system disclosed herein, wherein the Wearable Edge AI Chipset interoperates with the low power high resolution Cameras is constructed to be a Wearable Edge Device that can fit into wearable devices with power management capabilities to maximize power efficiency and minimize power consumption while providing the required AI TOPS (Tera Operations Per Second) performance in a 12 nm or less chip size for edge analytics processing, which is configured for wearable device use, including headsets and earpieces, or other wearable form factor designs.

The system disclosed herein, wherein the Wearable Edge AI Chipset functions in many environments and applications including car security, home security, or any other environments that has wireless communications including Bluetooth, WIFI, cellular or satellite.

The system disclosed herein, wherein each video stream is analyzed by the Wearable Edge AI Chipset to perform AI analytics including facial recognition, objects of interest, object behavior, behavior between objects, specific patterns of an object, specific patterns between objects, tracking of specific objects, or any other designed in AI analytics requirements to generate alerts to the user when specific programmed alert conditions are met including a) objects of interest including people, faces, vehicles, animals, structures, geographic locations, or any specific programmed objects or shapes of interest or any other designed in AI analytics requirements to generate alerts to the user when a predetermined event/condition is met; b) Object Behavior of Interest such as an object acting erratically, or a person starting to run; c) Object Behavior of Interest between objects including an object approaching another object rapidly, or an object falls after another object approaches and contacts it including an object approaching from behind; d) Object Pattern Recognition of an Object of Interest where an object of interest behaves in repeated patterns; e) Object Pattern Recognition between Objects of Interest where objects of interest behave in repeated patterns; or f) Object Tracking of Objects of Interest where Objects of Interest are identified and tracked between security devices.

In some embodiments, a wearable security device comprises a front view camera and a rear view camera configured to point in a different direction from the front view camera, wherein both the front and rear-view cameras transmit video images to a Wearable Edge AI Chipset to perform AI analytics on each video stream to generate alerts to the user when a predetermined event/condition is met.

In some embodiments, a wearable security system having a monthly subscription service comprises the wearable security device interoperates with a wireless communications subsystem capable of sending camera video stream by the means of either Bluetooth, WIFI communications to a smartphone, or smartwatch or smart pad for the purpose of AI analytics alerts, snapshots, and video streams display, wherein the wireless communications subsystem also has cellular uplink to transmit processed AI analytics alerts, snapshots, and video streams to a Cloud for further data analysis, image processing and storage.

The system disclosed herein, further comprises a head-mounted wearable security device. The system disclosed herein, further comprises a shoulder-mounted wearable. The system disclosed herein, further comprises a wearable security device mounting unit directly connected to the wearable security device.

In some embodiments, a car security system having a monthly subscription cost service comprising at least four or more In-Vehicle Cameras paired with the AI Gateway Device embedded with an AI Chipset in the AI Gateway Device with four or more USB-C or equivalent connector ports for the cameras if power connections are needed and if the cameras are not operating on battery power wherein the AI Gateway Device communicates with the Cloud through a cellular uplink or WIFI Local Area Network (LAN) in the AI Gateway, wherein a user can view the camera video streams, alerts and images generated by the AI Chipset embedded into the AI Gateway Device and display them by a mobile App on a Smartphone or Smartwatch or Smart Tablet, wherein the cameras are mounted inside a vehicle.

In some embodiments, a home security system comprises one or more cameras paired with the AI Gateway Device embedded with an AI Chipset in the AI Gateway Device with four or more USB-C or equivalent connector ports for the cameras if power connections are needed only if the cameras are not operating on battery power, wherein the AI Gateway Device communicates with the Cloud by using a cellular uplink or WIFI Local Area Network (LAN) in the AI Gateway, wherein a user can view the camera video streams, alerts and images generated by the AI Chipset embedded into the AI Gateway Device, and display them by using the mobile App on a Smartphone, Smartwatch or Smart Tablet, wherein the cameras are mounted on the interior or exterior of a home.

In some embodiments, a method for a user using an approved browser or a Mobile App login to the Unified Security System Cloud Application Programming Interface for 1) turning ON/OFF application functions; 2) configuring application functions; 3) generating reports; or 4) creating automaton tasks for the Home Security System, In-Vehicle Security System and Wearable Security System is provided.

In some embodiments, wherein the user using an approved browser or a Mobile App for login to the Unified Security System Home Gateway Device API instead of the Unified Security System Cloud Application Programming Interface for 1) turning ON/OFF application functions; 2) configuring application functions; 3) generating reports; or 4) creating automaton tasks for the Home Security System.

In some embodiments, wherein the user using an approved browser or a Mobile App login to the In-Vehicle Security Gateway Device API instead of the Unified Security System Cloud Application Programming Interface for 1) turning ON/OFF application functions; 2) configuring application functions; 3) generating reports; or 4) creating automaton tasks for the In-Vehicle Security System.

In some embodiments, wherein the user using an approved Mobile App instead of the Unified Security System Cloud Application Programming Interface for 1) turning ON/OFF application functions; 2) configuring application functions; 3) generating reports; or 4) creating automaton tasks for the Wearable Security System.

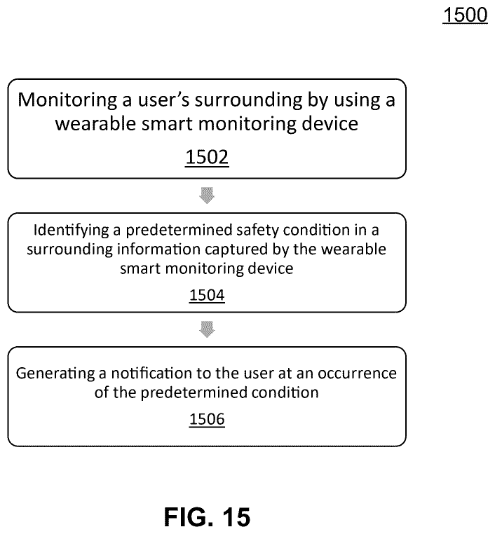

FIG. 15 illustrates a safety monitoring method 1500 in accordance with some embodiments. The method 1500 starts at a monitoring step 1502. The monitoring step 1502 is able to monitor a user's surroundings by using a wearable smart monitoring device, which can be the dual camera system disclosed herein. The monitoring is able to be set to monitor at a continuous monitoring, at a condition triggered monitoring, at a predetermined duration monitoring or at a specific location monitoring, among others.

Next, an identifying step 1504 is performed. The identifying step 1504 identifies a predetermined safety condition captured/identified by the wearable smart monitoring device. The predetermined safety condition includes identifying a weapon, identifying an enemy/hostile person (such as wearing a different uniform, angry facial expression, and motion of attacking or prepare to attack), identifying a recorded criminal or identifying a bad behavior person).

Next, a notification generation step 1506 is performed. At the notification generation step 1506, a notification is generated to notify the user of an occurrence of the predetermined condition. The notification is able to be a form of an alerting loud alarm (e.g., to scare of the potential treat), silent notification to the user (e.g., a vibration) so that the user is able to quietly escape or performing acts of mitigation, sending warning messages, images, or audios to a remote receiving/processing location or people.

In some embodiments, the systems and devices can be used as a child security device. The system is able to identify the face or other biological features of a child (or any other pre-determined person). The system sends out a warning or alert when the child is beyond a predetermined distance aways from the user, such as 10 m or 20 m.

In operation, the images and videos captured can be processed locally using the embedded edge AI system, which can be subsequently transmitted to be used further in a remote server.

In utilization, the security system disclosed here can be used to provide personal, vehicle, and home security.

The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims. Features in various examples or embodiments are applicable throughout the Present Specification.

What is claimed is:

1. An edge AI wearable security device comprising:
a) a front view camera coupled with a body of the edge AI wearable security device;
b) a rear view camera coupled with the body pointing at a different direction from the front view camera; and
c) a wearable edge AI processing unit in the body, wherein both the front view camera and rear view camera transmit video images to the wearable edge AI processing unit for performing AI analytics to generate alerts to a user at an occurrence of a predetermined condition.

2. The edge AI wearable security device of claim 1, wherein the wearable edge AI processing unit comprises an edge AI chip set.

3. The edge AI wearable security device of claim 1, wherein the front view camera points in a direction opposite to a direction that the rear view camera is pointing.

4. The edge AI wearable security device of claim 1, wherein the body is structured to be worn near an ear.

5. The edge AI wearable security device of claim 1, wherein the wearable edge AI processing unit is configured to identify the predetermined condition when a non-user is detected within a predetermined range of the user.

6. The edge AI wearable security device of claim 1, wherein the alerts are generated when the wearable edge AI processing unit identifies a non-user is approaching the user.

7. The edge AI wearable security device of claim 1, further comprising a communication unit configured to send an AI processed image to a smart device.

8. The edge AI wearable security device of claim 7, wherein the smart device comprises a watch, a smart phone, or a handheld electronic device.

9. A method of providing safety monitoring comprising:
a) monitoring a user's surrounding by using a wearable smart monitoring device;
b) identifying a predetermined safety condition from surrounding information captured by the wearable smart monitoring device; and
c) generating a notification to the user at an occurrence of the predetermined condition.

10. The method of claim 9, wherein the wearable smart monitoring device comprises at least two cameras pointing at two different directions.

11. The method of claim 9, wherein the surrounding information comprise a real-time audio, a real-time image, or both.

12. The method of claim 11, further comprising processing the real-time audio, the real-time image, or both by using an edge AI embedded chip set in the wearable smart monitoring device.

13. The method of claim 12, further comprising generating an edge AI processed safety information.

14. The method of claim 13, further comprising transmitting the edge AI processed safety information to a smart device.

15. The method of claim 14, wherein the smart device comprises a smart watch, a smart phone, or a display of a personal electronic device.

16. The method of claim 9, wherein the predetermined condition comprises an identified object of interest.

17. The method of claim 16, wherein the identified object of interest comprises one or more people, faces, vehicles, animals, structures, or geographic locations.

18. The method of claim 9, wherein the predetermined condition comprises an identified behavior of interest.

19. The method of claim 18, wherein the identified behavior of interest comprises a person or animal acting erratically or starting to run, a person or object approaching a user rapidly, or a person or object approaching a user from behind.

20. A property safety monitoring system comprising:
a) a portable property monitoring device having at least two edge AI embedded cameras;
b) an edge AI processing unit configured to identify a safety concern condition of a property and generate an AI processed safety information; and
c) a communication system configured to transmit the AI processed safety information to a remote receiving device.

21. The property safety monitoring system of claim 20, wherein the portable property monitoring device is configured to monitor the surroundings of an auto vehicle.

22. The property safety monitoring system of claim 20, wherein the portable property monitoring device is configured to monitor the surroundings of a building.

23. The property safety monitoring system of claim 20, wherein the portable property monitoring device comprises a rearview mirror in-vehicle device mount.

24. The property safety monitoring system of claim 23, further comprising a front driver side camera configured to monitor a condition of a driver and a front passenger sider camera configured to monitor a condition of a passenger.

25. The property safety monitoring system of claim 24, further comprising a rear cabin camera configured to monitor a condition of a rear seat passenger.

26. The property safety monitoring system of claim 20, wherein the AI processed safety information is transmitted to a cloud storage.

27. The property safety monitoring system of claim 26, wherein the AI processed safety information is transmitted from the cloud storage to a smart device.

28. The property safety monitoring system of claim 26, wherein the wearable device comprises a smart phone.

29. The property safety monitoring system of claim 26, wherein the AI processed safety information is transmitted from the cloud storage to a display of a wearable device.

30. The property safety monitoring system of claim 26, wherein the AI processed safety information is transmitted from the cloud storage to a Network Operation Center to be transmitted to a public network.
